(19) United States
(12) Patent Application Publication
(10) Pub. No.: US 2002/0067713 A1
(43) Pub. Date: Jun. 6, 2002

(54) Integrated switch for combined data and voice packets

(76) Inventor: Ronald F. D'Apuzzo, Toms River, NJ (US)

Correspondence Address: Kaplan & Gilman, LLP, 900 Route 9 North, Woodbridge, NJ, 07095, US

(21) Appl. No.: 09/729,440

(22) Filed: Dec. 4, 2000

(51) Int. Cl. H04L 12/66

(52) U.S. Cl. 370/352; 370/389

(57) ABSTRACT

An integrated switch used in a central office for switching combined data packets and voice packets, comprises a separator for separating between the different types of packets by reading the head information in the packets, and a router for routing the separate packets to their respective networks. The router further comprises a converter for translating the voice packets from the AAL2 protocol to the SS7/IMT protocol that can interface the public switched telephone network, and therefore eliminates the use of an expensive class 5 switch. The separator and the router including the converter are integrated in a single hardware platform and are controlled by a common program that runs on a single CPU.

### TECHNICAL FIELD

This invention relates to data and voice communications technologies, and more particularly, to an integrated switch used in a central office that is capable of switching incoming combined data and voice packets to their corresponding networks, based upon the dialed digits packets.

### BACKGROUND OF THE INVENTION

Due to the widespread use of packet data networks, various technologies, such as DSL (Digital Subscriber Line) technologies, have quickly developed for increasing the transmission speed as well as facilitating voice transmission over packet data networks as packets. With DSL technologies, data and voice circuits are carried from the customer premise to the central office (CO 1) over ATM (see FIG. 1). Both voice and data are carried as separate virtual circuits on the same physical interface until reaching the CO 1. Usually, a DSLAM 10 (Digital Subscriber Line Access Multiplexer) is also provided for multiplexing the data (and possibly voice packets) from multiple customers in order to transmit them over a high speed network to the CO 1.

In addition to the data packets, the signaling from the touch-tone telephone set is also transmitted as packets over the DSL line. In particular, a caller may utilize a regular touch-tone telephone set to place a call, and the instruction information such as the called number and feature activation codes are packetized as dialed digits packets and then transmitted to the central office (CO) 1 over a packet data network.

At the central office 1, the circuits are separated physically by a packet switch (e.g., ATM switch 2). The data circuit is routed to the data network 4, and the voice circuit including the dialed digits packets is routed to a class 5 switch 3 for telephone feature application. In the central office 1, the dialed digits packets are converted by the GR303 Gateway into a standard GR303 class 5 interface and then routed to the class 5 switch 3 for call processing and voice feature application. The class 5 switch 3 converts the signaling from the standard GR 303 interface to SS7/IMT interface that is suitable for transmission to PSTN (public switched telephone network) 5.

However, the class 5 switch and GR303 Gateway are very expensive and therefore substantially increases the cost of a central office. It is required, however, because the PSTN 5 is adapted to interface with such switches, not with packet switches such as ATM switch 2.

Therefore, there is a need for a new type of switching arrangement that can eliminate the expensive class 5 switch and GR303 Gateway without sacrificing its capability at the CO.

### SUMMARY OF THE INVENTION

The switch of the present invention comprises a separator for recognizing and distinguishing between the data packets and dialed digits packets and a router for routing them to their respective networks. The separator and the router are preferably integrated into a single piece of hardware and are under control of common software on the same CPU.

In particular, the switch preferably comprises a converter for translating the dialed digits packets from, for example, AAL2 protocol to the SS2/IMT protocol, and therefore the expensive class 5 switch and GR303 Gateway are eliminated. In general, by providing a packet switch that can implement telephony functions, direct communication from the packet switch to the public switched telephone network (PSTN) is facilitated.

### BRIEF DESCRIPTION OF THE DRAWINGS

The features and advantages of the present invention can be understood more clearly by reading the following detailed description of a preferred embodiment with reference to the accompanying drawings in which:

FIG. 1 is a schematic illustration of an arrangement of a central office in a prior art;

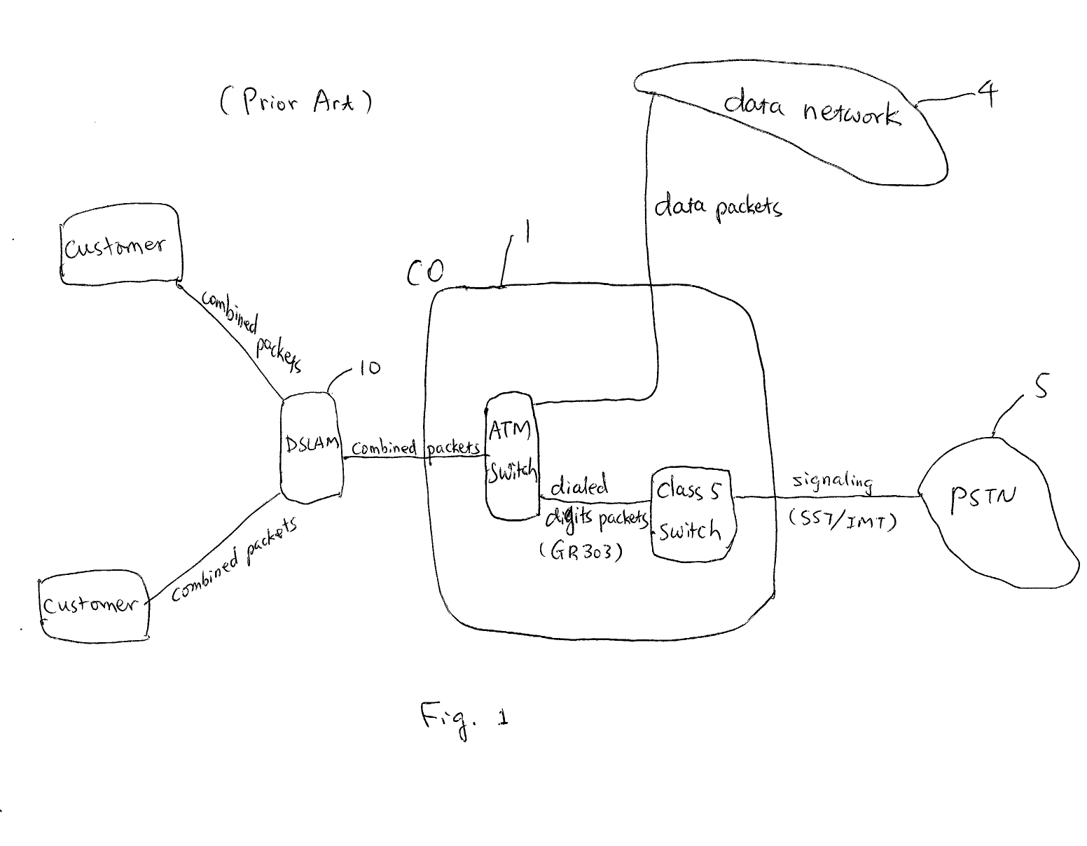

FIG. 2 is a schematic illustration of an arrangement of a central office that utilizing a switch of the present invention;

FIG. 3 is an illustration to show the switch in FIG. 2 of the present invention in more details.

FIG. 4 is an illustration to show how the combined packets are separated and routed by the integrated switch as shown in FIG. 3.

### DETAILED DESCRIPTION OF THE PREFERRED EMBODIMENT

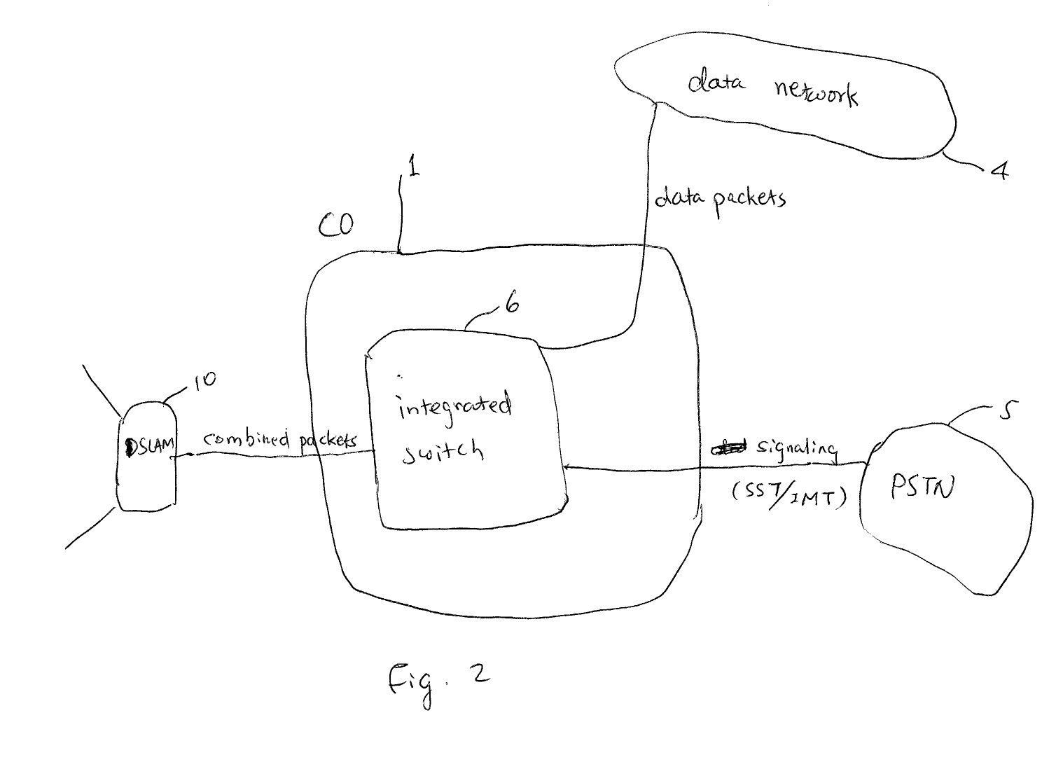

The novel integrated switch 6 of the present invention, as shown in FIG. 2, is directed to eliminate the use of an expensive class 5 switch and GR303 Gateway in the prior art. The incoming combined data and dialed digits packets are separated at the integrated switch 6.

The “dialed digits packets” are packetized data that contain the dialed digits in data format. Typically, such packets are understood and processed by packet switches, rather than conventional telephone switches. The data packets are routed to the data network 4 by the integrated switch 6, while the dialed digits are used for routing to the public switched telephone network, also by the integrated switch 6. The invention has the capability to provide CLASS 5 PSTN treatment directly, without any intermediate translation. The capability of the invention to provide both data and voice treatment, including call processing, eliminates the need for a separate voice switch. Instead of translating the dialed digits to GR303 and processing the signaling in a Class 5 switch, the dialed digits packets are converted directly to SS7 signaling, or other telephony signaling, that can be sent to and interpreted by the PSTN 5.

It is an important feature of the present invention that the integrated switch 6 not only distinguishes between the data packets, voice packets and dialed digits packets, and routes them to the respective networks 4 and 5, but also converts the dialed digits packets to a proper protocol, such as SS7/IMT, that can interface the PSTN 5. Therefore, there is no need to utilize a class 5 switch and a substantial cost is saved.

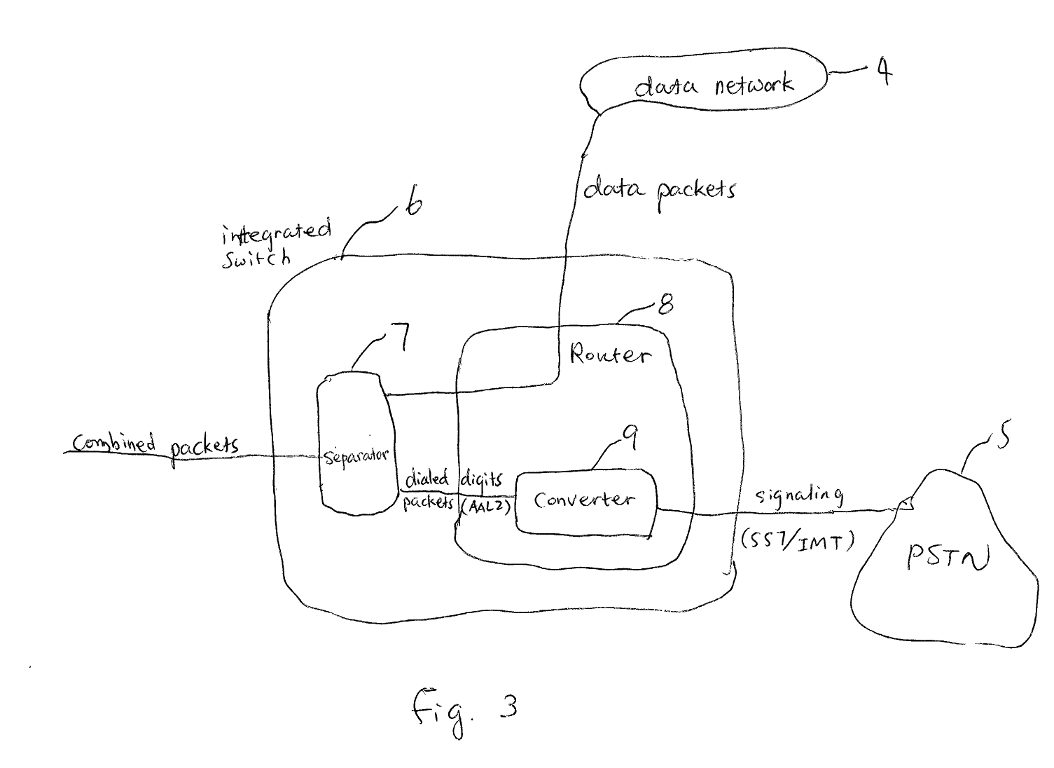

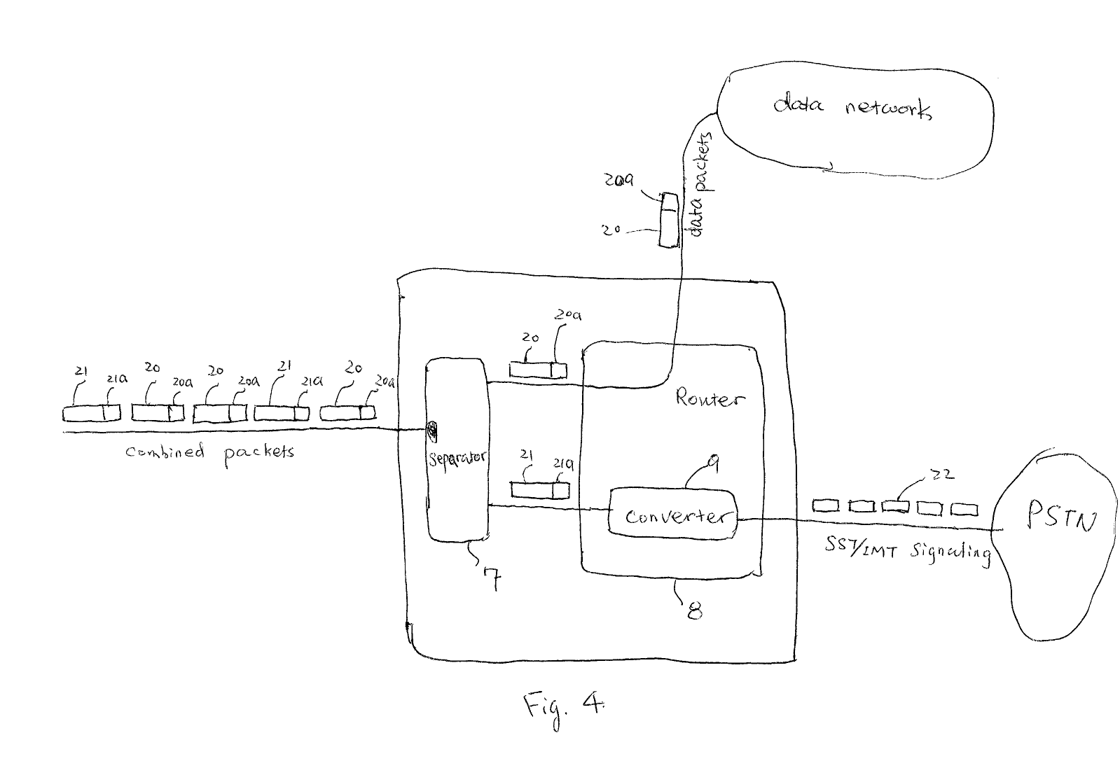

In particular, as shown in FIGS. 3 and 4, the integrated switch 6 of the present invention comprises two units—the separator 7 and the router 8, which are integrated in a single switch 6. Especially shown in FIG. 4, the incoming stream comprises data packets 20 and dialed digits packets 21. Each packet 20 or 21 has a header 20a or 21a, which comprises the information identifying the type of the packet. The separator 7 is capable of recognizing the type of packets, i.e., the data packets 20, voice packets, and the dialed digits packets 21 by reading the header information included in the header 20a and 21a in the incoming combined packets stream. After distinguishing the types of the packets 20 and 21, the separator 7 separates the data packets 20, voice packets and dialed digits packets 21. The separated packets 20 and 21 are further transmitted to the router 8, where they are routed to respective networks according to the information included in the header 20a and 21 a. That is, the data packets 20 are routed to the data network 4, and the dialed digits packets 21 are converted to PSTN protocol such as SS7 signaling 22 by a converter 9 and then routed to the PSTN 5.

An important unit of the integrated switch of the present invention is the router 8, which can translate the dialed digits packets into a protocol that is capable of interfacing the PSTN 5. In the AAL2 protocol discussed herein, there are packets which contain the digits normally conveyed over the telephone network using Dual Tone Multi-Frequency (DTMF) tones. As shown in FIGS. 3 and 4, the router 8 comprises a converter 9 which translates the dialed digits packets 21 in the AAL2 protocol into the SS7/IMT protocol signaling 22 which can interface the PSTN 5, whereby the use of an expensive class 5 switch and GR303 Gateway may be eliminated.

Even though the separator 7 and the router 8 are shown in FIG. 3 as separate units for illustration purposes, it is to be understood that they may be physically integrated into a single piece of hardware (the integrated switch 6) and may be controlled by the same program that is running on a single CPU. The converter 9 itself is also a software module that carries out the translation from the AAL2 protocol to the SS7/IMT protocol. The router, separator, and converter may run as different modules on a common DSP, or may run on separate DSPs or control processors.

The above describes the preferred embodiment of the present invention, but it shall be appreciated that numerous changes are possible to a person with ordinary skill in the art without departing from the spirit of the invention. For example, the integrated switch 6 is not only capable of separating and routing data packets and dialed digits packets, but also capable of separating packetized voice from the data packets and routing the voice packets to the data network. Therefore, the scope of the invention is solely defined in the claims.

What is claimed is:

1. A switch for switching incoming combined data and dialed digits packets, comprising:
a separator for recognizing and distinguishing between said data and dialed digits packets;
a router for routing said data packets to a packet switched network and said dialed digits packets to a telephone network;
wherein said separator and said router are integrated in a hardware platform and controlled by a common program.

2. The switch of claim 1 wherein said program is a module of software running on a single CPU within said switch.

3. The switch of claim 1 further comprising a converter for translating said dialed digits packets from AAL2 protocol to SS7/IMT protocol.

4. The switch of claim 3 wherein said converter is within said single hardware platform.

5. The switch of claim 4 wherein said converter is an integral part of said router.

6. The switch of claim 3 wherein said incoming dialed digits packets are in said AAL2 protocol.

7. The switch of claim 3 further comprising means for utilizing said SS7/IMT protocol to interface said telephone network.

8. The switch of claim 1 wherein said separator is capable of separating voice packets from said data packets and said dialed digits packets.

9. The switch of claim 7 wherein said router is capable of routing said voice packets to said telephone network.

10. The switch of claim 3 wherein said converter is also capable of translating voice packets from said AAL2 protocol to said SS7/IMT protocol.

11. A method of switching combined data and dialed digits packets, comprising:
receiving at a switch said combined data and dialed digits packets;
separating between said data packets and said dialed digits packets;
routing said data packets to a data network and said dialed digits packets to a public switched telephone network using signaling unique to said telephone network;
wherein said steps of separating and routing are carried out by a common program running on a CPU within said switch.

12. The method of claim 11 further comprising a step of translating said dialed digits packets from AAL2 protocol into SS7/IMT protocol.

13. The method of claim 12 wherein said step of translating is carried out by said common program.

14. The method of claim 13 wherein said step of translating is carried out within said switch such that said dialed digits packet come out from said switch as being of SS7/IMT protocol.

15. A method of transmitting dialed tone signaling over a network, comprising the steps of:
packetizing said dialed tone signaling into dialed digits packets;
multiplexing said dialed digits packets with data packets to form a combined packet stream and transmitting said stream to an integrated switch;
separating said dialed digits packets from said combined packet stream and routing them towards PSTN;
within said integrated switch, translating said dialed digits packets into signaling of a protocol that is capable of interfacing PSTN;
wherein said steps of separating, routing and translating are all implemented by a single hardware platform.

16. The method of claim 15 wherein said steps of separating, routing and translating are all controlled by a single software module running on a CPU within said integrated switch.

17. The method of claim 15 further comprising a step of routing said data packets to a packet data network.

18. The method of claim 15 wherein said protocol capable of interfacing said PSTN is a SS7/IMT protocol.

19. The method of claim 18 wherein said dialed digits packets are in AAL2 protocol.
